(19) United States
(12) Patent Application Publication
(10) Pub. No.: US 2023/0271522 A1
(43) Pub. Date: Aug. 31, 2023

(54) VEHICLE

(71) Applicant: TOYOTA JIDOSHA KABUSHIKI KAISHA, Toyota-shi Aichi-ken (JP)

(72) Inventors: Yoshiaki KIKUCHI, Toyota-shi Aichi-ken (JP); Hiroshi YOSHIDA, Anjo-shi Aichi-ken (JP); Akira KIYAMA, Toyota-shi Aichi-ken (JP); Yu SHIMIZU, Nagakute-shi Aichi-ken (JP); Kensaku MIYAZAWA, Toyota-shi Aichi-ken (JP); Takayuki OSHINO, Toyota-shi Aichi-ken (JP)

(73) Assignee: TOYOTA JIDOSHA KABUSHIKI KAISHA, Toyota-shi Aichi-ken (JP)

(21) Appl. No.: 18/086,780

(22) Filed: Dec. 22, 2022

(30) Foreign Application Priority Data
Feb. 25, 2022 (JP) 2022-028063

(51) Int. Cl. B60L 53/62

(52) U.S. Cl. CPC B60L 53/62

(57) ABSTRACT

A vehicle configured to perform external charging for charging an in-vehicle power storage device using electric power supplied from a system power supply outside the vehicle, wherein the vehicle includes a control device and a storage device. The control device is configured to set a command value of a charging current supplied from the system power supply to the power storage device through the charging device during the external charging, and to control the charging current by transmitting the command value to the charging device. The storage device is configured to store a program executed by the control device. The control device calculates an integrated value of the command value when the command value is larger than a threshold value. The control device is configured to execute a reduction process of reducing the command value when the integrated value is large than when the integrated value is small.

### CROSS-REFERENCE TO RELATED APPLICATION

This application claims priority to Japanese Patent Application No. 2022-028063 filed on Feb. 25, 2022, incorporated herein by reference in its entirety.

### BACKGROUND

### 1. Technical Field

The present disclosure relates to a vehicle.

### 2. Description of Related Art

Japanese Unexamined Patent Application Publication No. 2012-222895 (JP 2012-222895 A) discloses a vehicle. The vehicle includes a secondary battery, a current sensor, and a control device. The current sensor detects a charging current of the secondary battery. The control device controls charging of the secondary battery using a detection value of the current sensor. The control device integrates the detection value of the current sensor during charging of the secondary battery. When the integrated value exceeds the predetermined value, the control device limits a target charging amount of the secondary battery.

### SUMMARY

There has been known a vehicle capable of performing external charging for charging a power storage device mounted on the vehicle using power from a system power supply outside the vehicle. When the external charging is performed, a charging current supplied from the system power supply to the power storage device through a charging device may be large. Such a large charging current can lead to overheating of the power storage device.

In some cases, the control device cannot protect the power storage device from overheating using a detection value of a current sensor that detects the charging current. Even in such a case, in some embodiments, the control device may appropriately control the external charging in order to protect the power storage device from overheating.

The present disclosure has been made in order to solve the above issue, and an object thereof is to protect, in a vehicle capable of performing external charging, a power storage device mounted on the vehicle from overheating even when the power storage device mounted on the vehicle cannot be protected from overheating using a detection value of a charging current from a system power supply to the power storage device mounted on the vehicle.

A vehicle according to a first aspect of the present disclosure is a vehicle configured to perform external charging for charging a power storage device mounted on the vehicle using power supplied from a system power supply outside the vehicle, and the vehicle includes a control device and a storage device. The control device is configured to set a command value of a charging current supplied from the system power supply to the power storage device through a charging device during the external charging, and to control the charging current by transmitting the command value to the charging device. The storage device stores a program executed by the control device.

Here, the control device is configured to calculate an integrated value of the command value when the command value is larger than a threshold value, and execute a reduction process of reducing the command value when the integrated value is large as compared with when the integrated value is small.

As a larger amount of large charging current that exceeds the threshold value flows to the power storage device, the power storage device is more likely to be overheated. According to the above-described configuration, the charging current is reduced when the charging current larger than the threshold value flows more than when the charging current larger than the threshold value flows less. Accordingly, the amount of heat generated in the power storage device is reduced. As a result, the power storage device can be appropriately protected from overheating.

In the vehicle according to the first aspect, the control device may be configured to start the reduction process when the integrated value becomes equal to or larger than a reference value. According to such a configuration, the power storage device is charged without reducing the charging current until the integrated value reaches the reference value. This makes it possible to charge the power storage device while delaying a situation in which a charging speed of the power storage device decreases as much as possible.

In the vehicle according to the first aspect, the control device may be configured to set the command value such that supply of the charging current from the charging device to the power storage device is stopped when a charging rate of the power storage device increases to a threshold charging rate. Here, the control device may be configured to set the reference value to be lower as the charging rate increases to approach the threshold charging rate.

According to such a configuration, as charging of the power storage device progresses, the integrated value easily reaches the reference value. Accordingly, even when the supply of the charging current to the power storage device is not stopped at the time point when the charging rate is increased to the threshold charging rate, the charging current is easily reduced. As a result, even in such a case, the amount of heat generated in the power storage device can be easily reduced.

In the vehicle according to the first aspect, the control device may be configured to set the command value such that supply of the charging current from the charging device to the power storage device is stopped when a charging rate of the power storage device increases to a threshold charging rate. Here, the control device may be configured to set the threshold value to be lower as the charging rate increases to approach the threshold charging rate.

According to such a configuration, as charging of the power storage device progresses, the command value easily exceeds the threshold value. Thus, the command value is easily integrated, and therefore, the integrated value easily reaches the reference value. As a result, even when the supply of the charging current to the power storage device is not stopped at the time point when the charging rate is increased to the threshold charging rate, the charging current is easily reduced. Therefore, even in such a case, the amount of heat generated in the power storage device can be easily reduced.

In the vehicle according to the first aspect, the control device may be configured to reduce the command value as the integrated value increases in the reduction process. According to such a configuration, as a larger amount of large charging current that exceeds the threshold value flows to the power storage device, the charging current gradually decreases. Accordingly, the amount of heat generated in the power storage device can be gradually reduced. As a result, overheating of the power storage device can be effectively suppressed in advance.

According to the present disclosure, in a vehicle capable of performing external charging, a power storage device mounted on the vehicle can be protected from overheating even when the power storage device cannot be protected from overheating using a detection value of a charging current from a system power supply to the power storage device mounted on the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a charging system according to an embodiment;

FIG. 2 is a diagram showing in detail the configuration of a charging facility and a vehicle;

FIG. 3 is a diagram for explaining an exemplary reduction process executed by PWC-ECU during external charging;

FIG. 4 is a diagram for explaining how a PWC-ECU estimates an SOC of a battery;

FIG. 5 is a flowchart illustrating an example of a process executed in association with external charging in the embodiment;

FIG. 6 is a diagram for explaining another exemplary reduction process executed by PWC-ECU during external charging;

FIG. 7 is a diagram for explaining an example of the relation between SOC and the reference value RV in Modification 1;

FIG. 8 is a flowchart illustrating an example of processing executed during external charging in Modification 1;

FIG. 9 is a diagram for explaining an example of the relation between SOC and the threshold value THV in Modification 2.

### DETAILED DESCRIPTION OF EMBODIMENTS

Hereinafter, an embodiment will be described in detail with reference to the drawings. In the drawings, the same or corresponding parts are denoted by the same reference numerals, and the description thereof will not be repeated.

### Embodiment

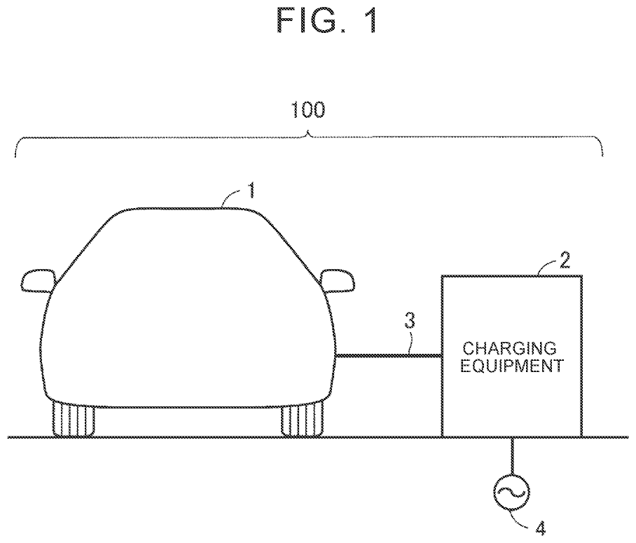

FIG. 1 is a diagram schematically illustrating an overall configuration of a charging system according to the present embodiment. As illustrated in FIG. 1, the charging system 100 includes a vehicle 1, a charging facility 2, and a charging cable 3.

The vehicle 1 is an electrified vehicle equipped with a power storage device. The vehicle 1 is configured to be capable of performing external charging for charging a power storage device using electric power supplied from a system power supply 4 (for example, a commercial power supply) outside the vehicle 1 through the charging facility 2. The vehicles 1 are, for example, battery electric vehicles (BEV: Battery Electric Vehicle) or Plug-in Hybrid Electric Vehicle (PHEV).

The charging facility 2 is, for example, a rapid charging facility (DC charging facility) provided in a public charging station. The charging facility 2 is configured to convert electric power from the system power supply 4 and supply the converted electric power to the vehicle 1.

The charging cable 3 is configured to electrically connect the charging facility 2 to the vehicle 1. The charging cable 3 transmits electric power from the charging facility 2 to the vehicle 1 during external charging of the vehicle 1.

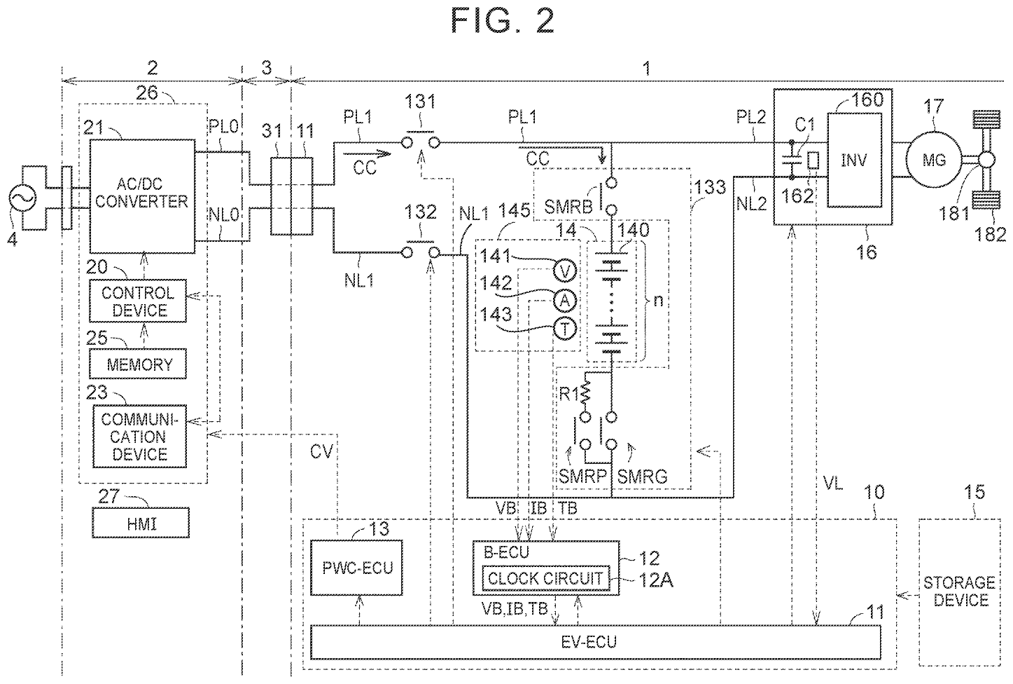

FIG. 2 is a diagram illustrating the configuration of the charging facility 2 and the vehicle 1 in detail. As illustrated in FIG. 2, the charging facility 2 includes a charging device 26, a power supply line PL0, NL0, and a HMI device 27.

The charging device 26 includes an AC/DC converter 21, a memory 25, a communication device 23, and a control device 20.

AC/DC converter 21 converts AC power supplied from the system power supply 4 into DC power. AC/DC converter 21 is configured to provide DC power to the power supply line PL0 on the positive electrode side and the power supply line NL0 on the negative electrode side while the vehicle 1 is being externally charged. The DC power is supplied as a charging power CC to a battery 14 (described later) of the vehicle 1 through a connector 31 of the charging cable 3. In this manner, AC/DC converter 21 is configured to charge the battery 14 using the power from the system power supply 4.

The memory 25 stores programs and data used by the control device 20. The memory 25 further stores information indicating a range of voltages and currents (charging current CC) that AC/DC converter 21 can supply to the vehicle 1 through the power supply line PL0,NL0.

The communication device 23 is configured to perform communication between the charging facility 2 and an external device (for example, the vehicle 1). This communication is, for example, Controller Area Network (CAN) communication or Power Line Communication (PLC) communication.

The control device 20 includes a processor such as a Central Processing Unit (CPU). The control device 20 is configured to receive a command from the vehicle 1 through a communication device 23 (described later) and control AC/DC converter 21 in accordance with the command. The control device 20 receives, for example, a command value CV of a direct current (charging current CC) supplied from AC/DC converter 21 to the vehicle 1 from the vehicle 1 through the communication device 23. Then, the control device controls AC/DC converter 21 so that the direct current of the command value CV is supplied from AC/DC converter 21 to the vehicles 1.

HMI device 27 receives an input of a user operation instructing a mode of operation of the charging facility 2. HMI device 27 is configured to receive, for example, an instruction for starting or stopping power supply from the charging facility 2 to the vehicles 1. HMI device 27 is also configured to be operated to set the voltage or current supplied from AC/DC converter 21 of the charging facility 2 to the inlet 11 of the vehicle 1 via the charging cable 3. Signals indicating the content of operations performed on HMI device 27 may be transmitted from the charging facility 2 to the vehicle 1.

The vehicle 1 includes an inlet 11, a charging relay 131, 132, a charging line PL1, NL1, and a system main relay (SMR: System Main Relay) 133. The vehicle 1 further includes a battery 14, a sensor unit 145, a power line PL2, NL2, and a Power Control Unit (PCU) 16. The vehicle 1 further includes a motor generator 17, a power transmission gear 181, drive wheels 182, a storage device 15, and a control device 10.

The inlet 11 is configured to be connected to the connector 31 of the charging cable 3. When the connector 31 is connected (inserted) to the inlet 11, the vehicle 1 is electrically connected to the charging facility 2. Then, the control device 10 of the vehicle 1 can communicate with the control device 20 of the charging facility 2.

The charging line PL1, NL1 is an electric path through which the charging current CC supplied from the charging device 26 to the vehicles 1 flows. A temperature sensor (not shown) for detecting the temperature of the charging line PL1, NL1 may be provided in the vehicle 1.

The charging relays 131 are connected to the charging line PL1. The charging relays 132 are connected to the charging line NL1. The open/close state of the charging relay 131, 132 is controlled in accordance with a command from the control device 10. The charging relay 131, 132 is provided to enable power transfer between the inlet 11 and the battery 14.

SMR 133 includes a relaying SMRB, SMRG, SMRP and a limiting resistor R1. The relay SMRB is connected to the charging line PL1. The relay SMRG is connected to the charging line NL1. The relay SMRP and the limiting resistor R1 are connected in series and connected in parallel to the relay SMRG. The open/close status of the relaying SMRB, SMRG, SMRP is controlled in accordance with a command from the control device 10.

For example, when the connector 31 of the charging cable 3 is connected to the inlet 11 (prior to starting the external charging), the relay SMRB, SMRP is controlled to be in the closed state, while the relay SMRG is controlled to be in the open state. Then, the capacitor C1 (described later) is precharged. When the precharge is completed, the relay SMRP is controlled to be in the open state while the relay SMRB is kept in the closed state, while the relay SMRG is controlled to be in the closed state. Thereafter, the external charging is started.

The battery 14 is a power storage device configured to store electric power for traveling of the vehicle 1. The battery 14 is an assembled battery including a plurality of cells 140 (the number of cells n≥2). Each cell 140 is a secondary battery such as a lithium ion secondary battery or a nickel metal hydride battery. The battery 14 may be replaced by a power storage device such as an electric double layer capacitor.

The sensor unit 145 includes a voltage sensor 141, a current sensor 142, and a temperature sensor 143. The voltage sensor 141 detects a voltage VB of the battery 14. The current sensor 142 detects a current D3 (for example, a charging current CC) input to and output from the battery 14. The temperature sensor 143 detects a temperature TB of the battery 14. Each sensor outputs the detection result to the control device 10.

The power line PL2 is configured to connect the positive electrode of the battery 14 to PCU 16. The power line NL2 is configured to connect the negative electrode of the battery 14 to PCU 16.

PCU 16 is provided between the battery 14 and the motor generator 17. PCU 16 includes a capacitor C1, a voltage sensor 162, and inverters 160.

The capacitor C1 is provided to smooth the voltage between the power line PL2 and the power line NL2. The capacitor C1 is also used for the aforementioned precharge.

The voltage sensor 162 detects a voltage VL across the capacitor C1, and outputs the detected voltage to the control device 10.

The inverter 160 is configured to drive the motor generator 17. PCU 16 may further include converters.

The motor generator 17 is an AC rotating electric machine, for example, a permanent magnet type synchronous motor including a rotor in which a permanent magnet is embedded. The output torque of the motor generator 17 is transmitted to the drive wheels 182 through the power transmission gear 181. As a result, the vehicle 1 travels.

The storage device 15 stores a program executed by the control device 10. The storage device 15 may be built in the control device 10.

The control device 10 includes a battery Electronic Control Unit (ECU) 12, a EV-ECU 11, and a PWC-ECU 13.

The battery ECU 12 is configured to obtain senses of voltage VB, current D3 (charging current CC), and temperature TB from the voltage sensor 141, the current sensor 142, and the temperature sensor 143 (sensor unit 145), respectively. The battery ECU 12 is also configured to communicate these detections to EV-ECU 11. The battery ECU 12 includes a clock circuit 12A. The clock circuit 12A outputs a clock signal to EV-ECU 11.

EV-ECU 11 is an upper ECU that controls the entire vehicle 1. EV-ECU 11 is configured to receive, from the battery ECU 12, a detection value of the sensor unit 145 as well as a detection value of the voltage VL. EV-ECU 11 is configured to communicate the received sensing to PWC-ECU 13. When a temperature sensor for detecting the temperature of the charging line PL1, NL1 is provided in the vehicle 1, EV-ECU 11 may be configured to receive the detected value and transmit the detected value to PWC-ECU 13. EV-ECU 11 may be configured to transmit a signal indicating the content of the manipulation performed on HMI device 27 to PWC-ECU 13 when the signal is received from the charging facility 2.

When the connector 31 of the charging cable 3 is connected to the inlet 11, EV-ECU 11 receives, from the charging facility 2, information indicating the range of the charging current CC that the charging device 26 can provide to the battery 14.

EV-ECU 11 is configured to determine whether an abnormality (failure) has occurred in the battery ECU 12 in accordance with a detected value of the sensor unit 145 and a clock signal from the clock circuit 12A. EV-ECU 11 is configured to determine that an abnormality has occurred in the battery ECU 12 when, for example, the frequency (clock frequency) of the clock signal is outside the reference frequency range or the detected value of the voltage sensor 141 of the sensor unit 145 is outside the normal range.

The above-described reference frequency range is determined in advance by experimentation as the frequency range of the clock-signal when no anomaly occurs in the battery ECU 12 (when normal). Similarly, the above-described normal range is determined in advance as a range that can be detected by the voltage sensor 141 when the battery ECU 12 is normal.

PWC-ECU 13 is configured to control the external charging of the vehicles 1. PWC-ECU 13 sets a command value CV of the charging current CC of the battery 14. PWC-ECU 13 is configured to receive a sensing of the sensor unit 145 from the battery ECU 12 through EV-ECU 11. PWC-ECU 13 may be configured to perform overheat protection control of the battery 14 using the sensor unit 145. For example, PWC-ECU 13 may be configured to set the command value CV such that the charging current CC is reduced when the time-integrated value of the detected value of the current 1B (charging current CC) reaches the reference integrated value.

PWC-ECU 13 is configured to perform charging control to control the charging current CC by transmitting a command value CV to the charging device 26 of the charging facility 2. PWC-ECU 13 is configured to terminate (stop) external charging when SOC of the battery 14 reaches the threshold value SOC (stop function of external charging). Specifically, PWC-ECU 13 is configured to set the command value CV (e.g., to 0) such that the charging current CC from the charging device 26 to the battery 14 is stopped. Alternatively, PWC-ECU 13 may send a request to terminate the external charging to the charging facility 2. The threshold value SOC is, for example, a value determined in advance as appropriate experimentally as a SOC when the battery 14 is fully charged. Methods of estimating SOC by PWC-ECU 13 will be described in detail later.

Each of EV-ECU 11, the battery ECU 12, and PWC-ECU 13 includes a processor and memories. The processor is, for example, a CPU. The memories include Read Only Memory (ROM) and Random Access Memory (RAM). Each of EV-ECU 11, the battery ECU 12, and PWC-ECU 13 executes various processes by executing programs stored in the storage device 15.

When the external charging of the vehicles 1 is performed, the charging current CC may be large. Such large charging current CC can lead to overheating of the battery 14.

The control device 10 may not be able to appropriately execute the overheat protection control of the battery 14 by using the detection value of the sensor unit 145. For example, although the charging current CC (current IB) is actually an excessive abnormal value that causes the battery 14 to overheat, the detected value of the charging current CC that EV-ECU 11 receives from the battery ECU 12 may be inaccurate due to an abnormal battery ECU 12.

In this case, EV-ECU 11 may erroneously determine that the detected value of the charging current CC, which is actually an abnormal value, is within the normal range. Therefore, EV-ECU 11 erroneously determines that the battery ECU 12 is normal, and cannot determine an anomaly in the battery ECU 12.

The control device 10 (more specifically, PWC-ECU 13) cannot adequately protect the battery 14 from overheating using the above-described inaccurate detections. For example, PWC-ECU 13 cannot adequately protect the battery 14 from overheating if the time integrated value is inaccurate due to an inaccurate detected value of the charging current CC despite PWC-ECU 13 being configured to perform overheating protection control of the battery 14 according to the time integrated value of the detected value of the charging current CC.

In some embodiments, even when the control device 10 cannot protect the battery 14 from overheating by using the detection value of the sensor unit 145, the control device 10 may appropriately controls the external charging in order to protect the battery 14 from overheating.

The vehicle 1 according to the present embodiment includes a configuration for dealing with the above-described problem. Specifically, the control device 10 (more specifically, PWC-ECU 13) of the vehicle 1 calculates the integrated value (time-integrated value) of the command value CV when the command value CV exceeds the threshold value. When the integrated value is large, the control device 10 reduces the command value CV more than when the integrated value is small. Hereinafter, the process of reducing the command value CV in this manner is also referred to as a “reduction process”.

The more charging current CC that exceeds the threshold value flows to the battery 14, the more likely the battery 14 may overheat. According to the above configuration, when such a charging current CC flows, the charging current CC is reduced more than when such a charging current CC flows less. Accordingly, the amount of heat generated in the battery 14 is reduced. Consequently, even when the battery 14 cannot be protected from overheating by using the detected value (current IB) of the charging current CC, the battery 14 can be appropriately protected from overheating.

Hereinafter, as an exemplary case where the control device 10 cannot protect the battery 14 from overheating by using the detected value of the charging current CC, it is mainly assumed that an abnormality has occurred in the battery ECU 12 and EV-ECU 11 cannot determine the abnormality of the battery ECU 12.

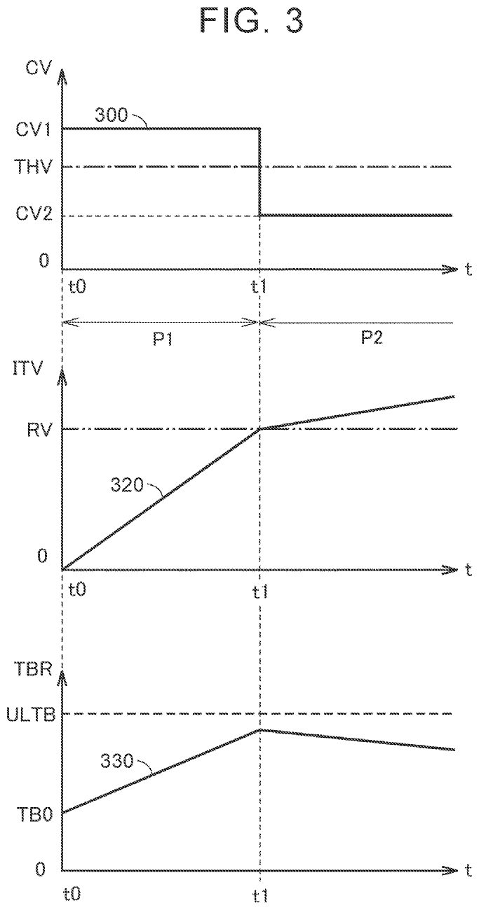

FIG. 3 is a diagram for explaining an exemplary reduction process executed by PWC-ECU 13 during external charging.

In FIG. 3, the time t0 is a starting time of external charging. A line 300 indicates the transition of the command value CV during the external charging.

A line 320 indicates the transition of the integrated value ITV during the external charging. The integrated value ITV is sequentially calculated by PWC-ECU 13 when the command value CV exceeds the threshold value THV. The threshold value THV is appropriately determined in advance experimentally as a value at which the battery 14 does not overheat as long as the charging current CC equal to or lower than the threshold value THV is supplied to the battery 14. In this instance, the threshold value THV is a fixed value pre-stored in PWC-ECU 13's memories.

A line 330 indicates the transition of the actual temperature TBR of the battery 14 during external charging. In this embodiment, since an abnormality occurs in the battery ECU 12, it is assumed that the detected value (temperature TB) of the temperature sensor 143 received by EV-ECU 11 from the battery ECU 12 is an abnormal value. Therefore, an actual temperature TBR is shown instead of the temperature TB as a temperature for representing the temperature of the battery 14.

During the time P1 from the time t0 to the time t1, the command value CV is a command value CV1 that is larger as the threshold value THV is exceeded (line 300). As a result, as the threshold value THV is exceeded, a larger charging current CC is continuously supplied to the battery 14. The setting of the command value CV will be described in detail later. PWC-ECU 13 sequentially calculates the integrated value ITV of the command value CV(=CV1>THV). Consequently, the integrated value ITV continues to grow (line 320). The actual temperature TBR increases (line 330) as the high charging current CC continues to be supplied to the battery 14.

In the time t1, when the integrated value ITV reaches the reference value RV, PWC-ECU 13 starts the above-described reduction process. In this instance, PWC-ECU 13 sets the command value CV during the period P2 after the period P1 to a command value CV2 that is lower than the command value CV1 (line 300). The reference value RV is a fixed value determined in advance as a value at which the battery 14 does not overheat as long as the integrated value ITV is less than the reference value RV, and is stored in advance in PWC-ECU 13 memories.

When the command value CV is set to the command value CV2 as described above, the command value CV2 is transmitted from PWC-ECU 13 to the charging device 26 instead of the command value CV1. Consequently, the charging current CC is reduced from CV1 to CV2. Therefore, the amount of heat generated in the battery 14 is reduced. In this case, since the amount of heat dissipation of the battery 14 is larger than the amount of heat generation during the period P2, the actual temperature TBR gradually decreases (line 330).

Consequently, a situation in which the battery 14 is overheated due to the fact that the actual temperature TBR becomes equal to or higher than the upper limit temperature ULTB is avoided. The upper limit temperature ULTB is determined in advance as a temperature at which the battery 14 may overheat when the actual temperature TBR becomes equal to or higher than the upper limit temperature ULTB.

In this embodiment, the battery 14 is charged while the charging current CC is maintained without being reduced until the integrated value ITV reaches the reference value RV at the time t1 (during the period P1). This makes it possible to charge the battery 14 while delaying a situation in which the charging speed of the battery 14 decreases as much as possible.

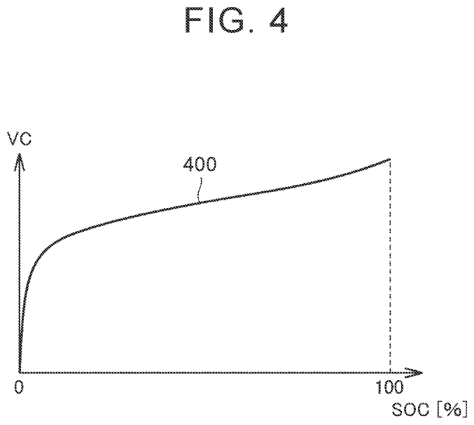

FIG. 4 is a diagram for explaining how PWC-ECU 13 estimates SOC of the battery 14.

In FIG. 4, a line 400 indicates a relation between the cell voltage VC, which is the voltage of the cell 140 of the battery 14, and SOC. The relation between the lines 400 is determined in advance as appropriate by experimentation, and is stored in the memories of PWC-ECU 13.

PWC-ECU 13 estimates the cell voltage VC by dividing the voltage VL (FIG. 1) by the number-of-cells n (VC=VL/n). PWC-ECU 13 then estimates SOC according to the cell-voltage VC and the relation of the lines 400.

PWC-ECU 13 estimates, for example, the cell voltage VC at the beginning of the external charging as the voltage VL at that time divided by the number of cells n. The voltage VL at the time of starting the external charging is a voltage VL at the time when the precharge of the capacitor C1 using the relay SMRB, SMRP, SMRG is completed after the connector 31 of the charging cable 3 is connected to the inlet 11.

PWC-ECU 13 receives from EV-ECU 11 information including a range of the charging current CC that the charging facility 2 can provide to the battery 14 and the temperature of the charging line PL1, NL1. PWC-ECU 13 sets the command value CV according to this data. For example, PWC-ECU 13 sets the command value CV of the charging current CC such that the component such as the charging line PL1, NL1 does not overheat (the temperature of the charging line PL1, NL1 is less than the predetermined threshold temperature) and the charging current CC increases as much as possible within the above range. The relation between the temperature of the charging line PL1, NL1 and the command value CV may be stored in advance in PWC-ECU 13 as a map, for example.

PWC-ECU 13 may further set the command value CV according to SOC. For example, PWC-ECU 13 may set the command value CV such that the higher SOC, the lower the charging current CC. Thus, even when the charging capacity of the battery 14 (the quantity of the charging current CC acceptable to the battery 14) decreases as SOC increases, the battery 14 can be charged using the charging current CC suitable for the charging capacity.

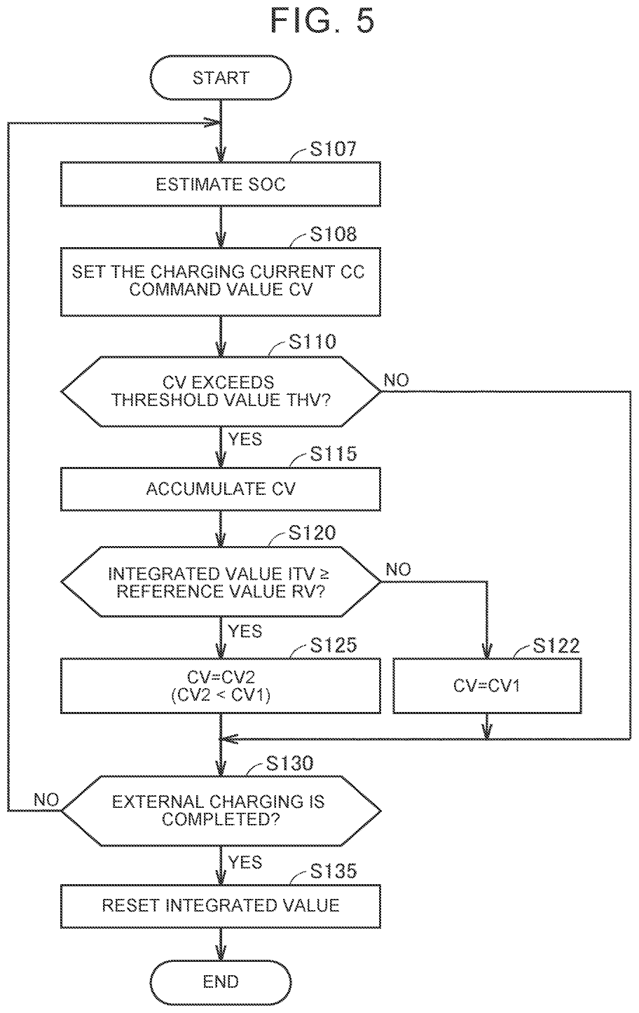

FIG. 5 is a flowchart illustrating an example of a process executed in connection with external charging in the present embodiment. The process of this flow chart is started when the user instructs to start external charging using HMI device 27 while the connector 31 of the charging cable 3 is connected to the inlet 11. In the following description, reference is made to FIG. 3 as appropriate.

As shown in FIG. 5, PWC-ECU 13 estimates SOC according to the cell-voltage VC and the relation of the line 400 (step S107). PWC-ECU 13 estimates, for example, SOC at the beginning of the external charging.

Next, PWC-ECU 13 sets a command value CV of the charging current CC (step S108). In this case, it is assumed that the default value of the command value CV is the command value CV1.

Next, PWC-ECU 13 switches the process according to whether or not the command value CV exceeds the threshold value THV (FIG. 3) (step S110). When the command value CV is equal to or less than the threshold value THV (NO in S110 of steps), the charging current CC is relatively small, and thus the possibility that the battery 14 is overheated is low. The process then proceeds to step S130. On the other hand, when the command value CV exceeds the threshold value THV (YES in S110 of steps), the charging current CC is relatively large. Then, the process proceeds to step S115.

Next, PWC-ECU 13 calculates the integrated value ITV by integrating the command value CV (step S115).

Next, PWC-ECU 13 switches the process according to whether or not the integrated value ITV is equal to or greater than the reference value RV (FIG. 3) (step S120). If the integrated value ITV is less than the reference value RV (NO in step S120), PWC-ECU 13 sets the command value CV to the command value CV1 (step S122). That is, in this embodiment, the command value CV is maintained at the default value.

On the other hand, when the integrated value ITV is equal to or larger than the reference value RV (YES in step S120), PWC-ECU 13 determines that an error has occurred in the battery ECU 12, and sets the command value CV to a command value CV2 lower than the command value CV1 (step S125). That is, PWC-ECU 13 reduces the command value CV before the integrated value ITV reaches the reference value RV. After step S122 or step S125, the process proceeds to step S130.

Then, PWC-ECU 13 determines whether or not the external charging has been completed (step S130). In this instance, PWC-ECU 13 determines whether SOC of the battery 14 has reached the aforementioned threshold value SOC.

If the external charging has not been completed (NO in step S130), the process returns to step S107. Then, the process of step S107 to step S125 is repeated until the external charging is completed.

On the other hand, when the external charging is completed (YES in step S130), PWC-ECU 13 resets the integrated value ITV to its default value (0 in this example) (step S135). Thereafter, the series of processes in FIG. 5 ends.

PWC-ECU 13 may execute the determination process of the step S130 according to whether the user instructs to stop the power supply from the charging facility 2 to the vehicles 1 using HMI device 27 of the charging facility 2. For example, when this instruction is given, the process proceeds from step S130 to step S135. On the other hand, if this instruction is not performed, the process returns from the step S130 to the step S107.

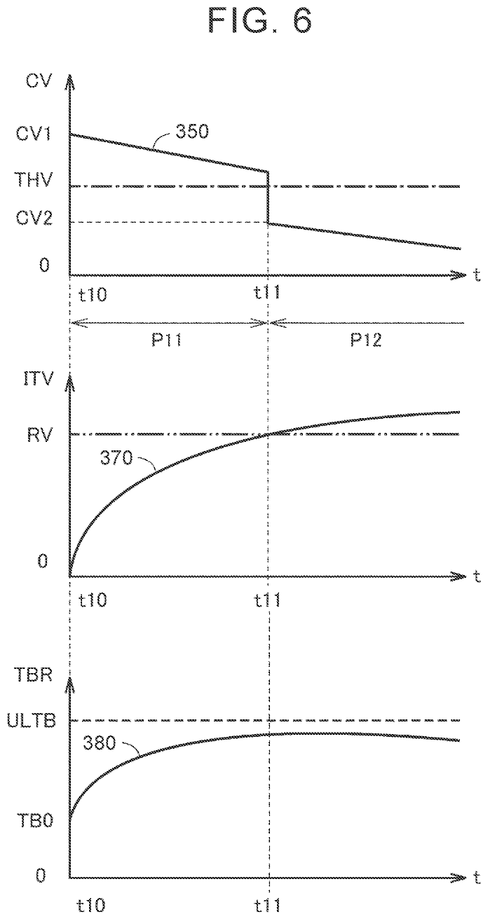

FIG. 6 is a diagram for explaining another exemplary reduction process executed by PWC-ECU 13 during external charging.

In FIG. 6, the time t10 is the starting time of external charging. The command value CV1, CV2, the threshold value THV, the reference value RV, and the actual temperature TBR are the same as those in FIG. 3.

A line 350 indicates the transition of the command value CV during the external charging. A line 370 indicates the transition of the integrated value ITV during the external charging. A line 380 indicates the transition of the actual temperature TBR of the battery 14 during external charging.

During the time P11 from the time t10 to the time t11, PWC-ECU 13 sequentially calculates the integrated value ITV of the command value CV(>THV). Then, PWC-ECU 13 decreases the command value CV as the integrated value ITV increases (line 350, 370). As a result, the larger the charging current CC flows to the battery 14 as the threshold value THV is exceeded, the smaller the charging current CC gradually decreases. As a result, the amount of heat generated in the battery 14 can be gradually reduced, so that a situation in which the actual temperature TBR excessively increases can be avoided (line 380). As a result, overheating of the battery 14 can be effectively prevented.

In this instance, PWC-ECU 13 reduces the command value CV as described above even during the period P12 after the period P11.

As described above, the reduction process is not limited to the process of setting the command value CV so that the charging current CC is maintained until the integrated value ITV reaches the reference value RV (line 300 in FIG. 3).

### Modification 1 of the Embodiment

In the embodiment and the first modification thereof, the reference value RV is a fixed value. In contrast, the reference value RV may vary according to SOC of the battery 14.

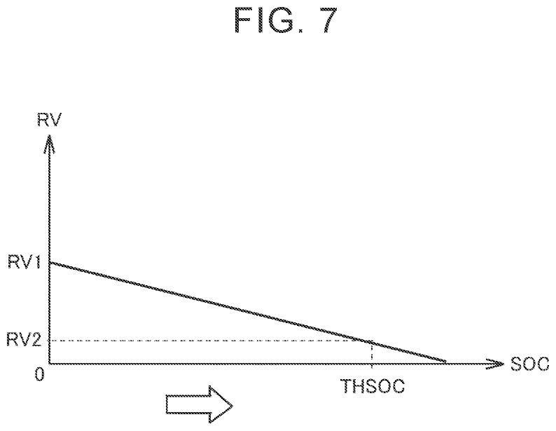

FIG. 7 is a diagram for explaining an example of the relation between SOC and the reference value RV in Modification 1. PWC-ECU 13 is configured to set the reference value RV lower as SOC increases toward the threshold value SOC(THSOC). In this case, when SOC changes from 0 to the threshold value SOC (THSOC), the reference value RV changes from the reference value RV1 to the reference value RV2 (RV1>RV2≥0).

When the reference value RV is set in this way, the more the battery 14 is charged, the easier the integrated value ITV reaches the reference value RV. Accordingly, even when the supply of the charging current CC to the battery 14 is not stopped at the time when SOC is raised to the threshold value SOC (THSOC (for example, when the external charging stopping function in PWC-ECU 13 is not normally performed), the charging current CC is easily reduced. As a result, even in such a case, the amount of heat generated in the battery 14 can be easily reduced. That is, the reduction process can function as a fail-safe of the function of stopping external charging. In this case, even if SOC exceeds the threshold value SOC (THSOC), the reference value RV is finally set to 0. Consequently, a situation in which a large charging current CC continues to be supplied to the battery 14 can be avoided.

The fail-safe function is particularly effective when SOC is higher and the charging current CC is lower (e.g., PWC-ECU 13 sets the command value CV such that the charging current CC is substantially zero as SOC approaches the threshold value SOC).

With the connector 31 of the charging cable 3 connected to the inlet 11, it is also conceivable that the starting and stopping of the external charging is repeated by the user using HMI device 27 for a short period of time. In such cases, even if the integrated value ITV is reset once at the end of the external charging, SOC is estimated thereafter, and the reference value RV is appropriately set in accordance with SOC. Consequently, it is possible to avoid a situation in which it is difficult to reach the reference value RV because the integrated value ITV is reset once.

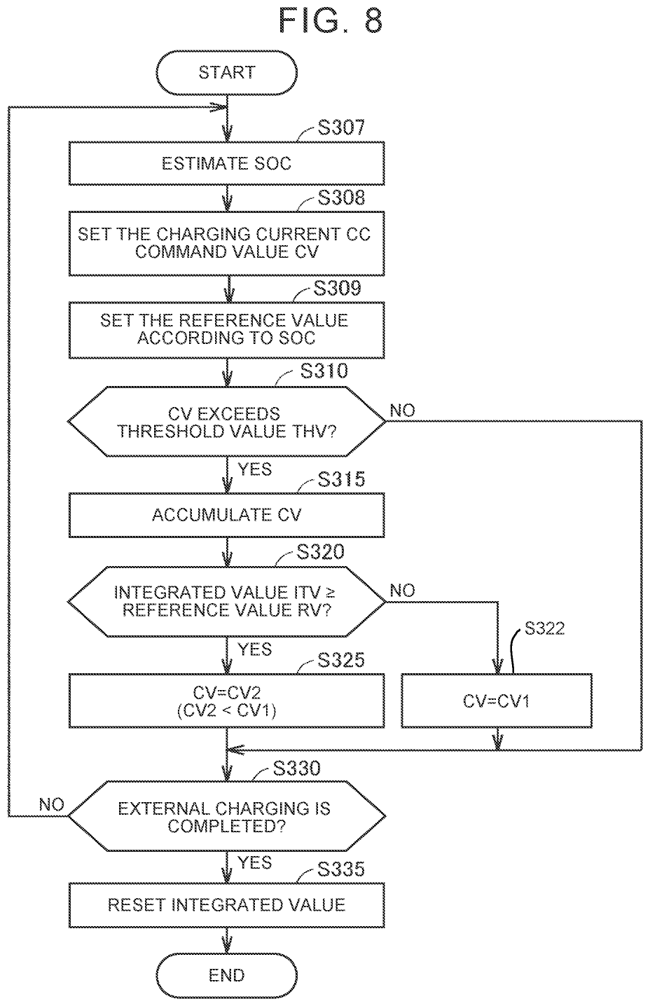

FIG. 8 is a flowchart illustrating an example of a process executed during external charging in Modification 1. The process of this flow chart is started when the user instructs to start external charging using HMI device 27 while the connector 31 of the charging cable 3 is connected to the inlet 11.

Referring to FIG. 8, this flowchart differs from the flowchart of the embodiment (FIG. 5) in that the process of the step S309 is added. The processing from step S307 to step S308 and the processing from step S310 to step S335 are the same as the processing from step S107 to step S108 and from step S110 to step S135, respectively.

After estimating SOC (after step S307), PWC-ECU 13 sets the command value CV of the charging current CC (step S308), and sets the reference value RV according to SOC (step S309). Specifically, PWC-ECU 13 sets the reference value RV lower as SOC is higher (FIG. 7). Thereafter, the process proceeds to step S310.

### Modification 2 of the Embodiment

In the embodiment and the first modification thereof, the threshold value THV is assumed to be a fixed value. In contrast, the threshold value THV may vary according to SOC of the battery 14.

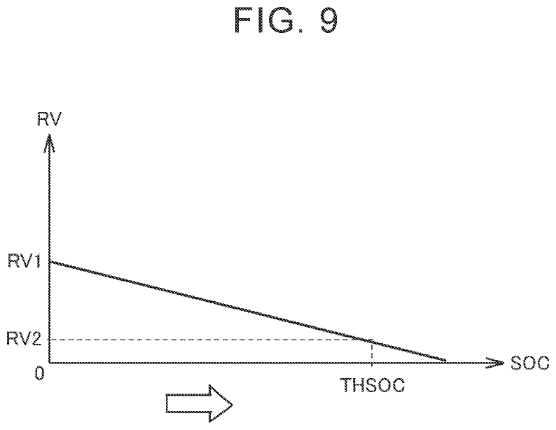

FIG. 9 is a diagram for explaining an example of the relation between SOC and the threshold value THV in Modification 2. PWC-ECU 13 is configured to set the threshold value THV lower as SOC increases toward the threshold value SOC(THSOC). In this case, when SOC changes from 0 to the threshold value SOC(THSOC), the threshold value THV changes from the threshold value THV1 to the threshold value THV2 (THV1>THV2≥0).

When the threshold value THV is set as described above, as the battery 14 is charged, the command value CV tends to exceed the threshold value THV. Accordingly, since the command value CV is easily integrated, the integrated value ITV easily reaches the reference value RV. Consequently, even if the supply of the charging current CC to the battery 14 is not stopped at the time when SOC rises to the threshold value SOC, the charging current CC is easily reduced. Therefore, even in such a case, the amount of heat generated in the battery 14 can be easily reduced. That is, as in the case of the first modification, the reduction process can function as fail-safe of the function of stopping the external charging.

### Other Modifications

In the embodiment and the modifications 1 to 2, it is assumed that the in-vehicle charging device (power conversion device) is not provided between the charging device 26 of the charging facility 2 and the battery 14 of the vehicle 1.

On the other hand, such an in-vehicle charging device may be provided in the vehicle 1. Specifically, the in-vehicle charging device is configured to convert electric power supplied from the charging device 26 of the charging facility 2 to the vehicle 1 through the inlet 11 and supply the converted electric power to the battery 14 as charging electric power.

When such an in-vehicle charging device is provided in the vehicle 1, PWC-ECU 13 may be configured to control the external charging of the vehicle 1 by setting a command value of the charging current from the in-vehicle charging device to the battery 14 and transmitting the command value to the in-vehicle charging device.

Specifically, PWC-ECU 13 calculates the integrated value of the charging current when the charging current larger than the threshold value THV is supplied from the in-vehicle charging device to the battery 14. When the integrated value is large, the above-described command value may be reduced than when the integrated value is small. As described above, the “charging device” of the present disclosure is not limited to the charging device 26 mounted in the charging facility 2, and may be the above-described in-vehicle charging device.

What is claimed is:

1. A vehicle configured to perform external charging for charging a power storage device mounted on the vehicle using power supplied from a system power supply outside the vehicle, the vehicle comprising:
a control device configured to set a command value of a charging current supplied from the system power supply to the power storage device through a charging device during the external charging, and to control the charging current by transmitting the command value to the charging device; and
a storage device that stores a program executed by the control device, wherein the control device is configured to
calculate an integrated value of the command value when the command value is larger than a threshold value, and
execute a reduction process of reducing the command value when the integrated value is large as compared with when the integrated value is small.

2. The vehicle according to claim 1, wherein the control device is configured to start the reduction process when the integrated value becomes equal to or larger than a reference value.

3. The vehicle according to claim 2, wherein:
the control device is configured to set the command value such that supply of the charging current from the charging device to the power storage device is stopped when a charging rate of the power storage device increases to a threshold charging rate; and
the control device is configured to set the reference value to be lower as the charging rate increases to approach the threshold charging rate.

4. The vehicle according to claim 1, wherein:
the control device is configured to set the command value such that supply of the charging current from the charging device to the power storage device is stopped when a charging rate of the power storage device increases to a threshold charging rate; and
the control device is configured to set the threshold value to be lower as the charging rate increases to approach the threshold charging rate.

5. The vehicle according to claim 1, wherein the control device is configured to reduce the command value as the integrated value increases in the reduction process.
